(19) United States
(12) Patent Application Publication
(10) Pub. No.: US 2017/0288726 A1
(43) Pub. Date: Oct. 5, 2017

(54) METHODS AND SYSTEMS FOR SPREAD SPECTRUM COMMUNICATIONS

(71) Applicant: SOCOVAR SOCIETE EN COMMANDITE, MONTREAL (CA)

(72) Inventors: GEORGES KADDOUM, MONTREAL (CA); YOGESH ANIL NIJSURE, MONTREAL (CA); FAROUK ABDELLATIF AHMED MOHAMMED, MONTREAL (CA)

(21) Appl. No.: 15/508,287

(22) PCT Filed: Sep. 1, 2015
(86) PCT No.: PCT/CA2015/000480

§ 371 Date: Mar. 2, 2017

Related U.S. Application Data
(60) Provisional application No. 62/044,568, filed on Sep. 2, 2014.

(51) Int. Cl. H04B 1/707

(52) U.S. Cl. CPC H04B 1/707

(57) ABSTRACT

Wireless communications have become ubiquitous for society with the availability of low cost front end transmitter and receiver circuits. Network operators strive to provide wireless signals with good Signal to Noise and Interference Ratio (SNIR) whilst increasing useable network capacity and bandwidth using maximum over-the-air data rate and controlling or minimizing over-the-air congestion. Historically this has been achieved via evolutions of network and consumer hardware, firmware, software and hence it would be beneficial to provide network operators with a means of increasing network capacity without requiring either additional hardware complexity and/or additional computational complexity in the receiving devices. The inventor has established a new domain within the network, the spreading code domain, to increase the data rate, by using spreading codes to map the data in conjunction with the constellation symbols and reduce the amount of transmitted data required.

### FIELD OF THE INVENTION

This invention relates to spread spectrum communications and more particularly to high data rate and low energy communications by exploiting the code index domain.

### BACKGROUND OF THE INVENTION

Wireless communications have become ubiquitous for society over the past twenty years with the availability of low cost front end transmitter and receiver circuits. Whilst 50 years ago the average consumer would merely access wireless broadcasts with a radio today they are most likely to exploit a smartphone operating upon one wireless standard, e.g. Global System for Mobile Communications (GSM), allowing them to make/receive telephone calls, send/receive electronic mail, engage in simple message services (SMS), stream audiovisual content and access electronic content on the Internet. In 2010 with a global population of approximately 6.9 billion there were an estimated 5 billion active cellphone connections globally (see BBC Jul. 18, 2010 news report http://www.bbc.co.uk/news/10569081 citing market analysts Wireless Intelligence).

At the same time in addition to smartphones and cellular telephones wireless communication systems today have fundamentally changed how consumers, advertisers, and enterprises interact, communicate, exchange, store, and utilize information through a variety of formats with a variety of mobile wireless devices including personal digital assistants (PDAs), laptops, tablet PCs, portable multimedia players, and portable gaming consoles. They are also quite likely to be using other electronic devices associated with the smartphone through a second wireless standard, e.g. Bluetooth, for headphones, fitness monitoring, wearable devices etc.

Accordingly, network operators strive to provide resilient connectivity between each user device, typically referred to as a station or STA, and the network node, typically referred to as am access point or AP. Resilient connectivity means that each STA sees a good wireless (RF) signal with good Signal to Noise and Interference Ratio (SNIR). Further, increasing useable network capacity and bandwidth means that each STA can transmit and receive packets using maximum over-the-air data rate and that over-the-air congestion is either controlled or minimized. Further, network operators striving to enhance service quality seek to ensure delay, loss and jitter are managed to levels where real time services perform.

Accordingly, today network operators strive continuously to attain the best utilization of the radio spectrum, i.e. high spectral efficiency, allowing them to support the demands for increasing data rates, the number of networked devices and the quality and types of wireless services. In many instances these are within the confines of narrow frequency allocations. Additionally, in recent years, energy consumption has become a critical factor for the design of wireless networks either to reduce the energy cost and carbon footprint of high power cellular networks or to extend the battery lifetime of consumer portable devices. Furthermore, wireless technologies are being utilized in variety of new scenarios which are characterized by low energy consumption such as wireless body area networks (WBANs), wireless sensor networks (WSNs), and satellite communication systems. Consequently, it would be beneficial to provide innovative schemes that achieve both high data rates and energy efficiency.

With many believing the limits of current general spatial modulation techniques, that have evolved from 1G through to 4G networks and devices together with Long Term Evolution (LTE) and Enhanced Data rates for GSM Evolution (EDGE) etc., have been reached one key aspect of current technology development for significantly increasing the capacity of a wireless channel is Multi-Input Multi-Output (MIMO) wireless communications. MIMO offers significant increases in data throughput and link range without additional bandwidth or increased transmit power. It achieves this by spreading the same total transmit power over multiple antennas to achieve an array gain that improves the spectral efficiency (more bits per second per hertz of bandwidth) and/or to achieve a diversity gain that improves the link reliability (reduced fading). However, signal detection in MIIVIO systems is computationally expensive in general and its realization requires a dedicated RF chain at each antenna. Therefore, current research efforts focus on reducing the computations and hardware cost of the MIIVIO to achieve practical systems.

One such approach is so-called spatial modulation (SM) which potentially offers a low complexity variation to the MIMO scheme in that only one transmit antenna is activated within each time slot. Hence, if we consider M as the constellation size of the digital modulation scheme and N to be the number of transmit antennas, then log, (M) bits are mapped to the constellation symbols and log, (N) bits are mapped to the transmit antenna number. This setting achieves high data rate with lower complexity as compared to the conventional MIMO and avoids inter-channel interference (ICI) and antenna synchronisation. Moreover, a generalized spatial modulation (GSM) has been proposed where more than one transmits antenna is activated within each time slot, but still not the full array. In this case, the bit rate grows considerably faster with the number of transmit antennas rather than logarithmically as in the case with SM. However, this comes with the cost of more complicated receiver for the GSM scenario than the SM one and the requirement to now addresses the existence of inter-channel interference.

Accordingly, it would be beneficial to provide network operators with a means of increasing network capacity without requiring either additional hardware complexity and/or additional computational complexity in the receiving devices. According, the inventor has established a new domain within the network, the spreading code domain, aiming at increasing the data rate. The proposed system, which the inventor calls code index modulation (CIM), achieves high data rate than conventional spread spectrum systems and can be integrated easily with the MIMO or SM systems to achieve higher throughput. It uses spreading codes to map the data in conjunction with the constellation symbols and reduce the data transmitted by (N_{b}−n)/N_{b}*100% in embodiments of the invention where n is the number of transmitted bits and N_{b} the number of total bits in the block such that (N_{b}−n) is the number of mapped bits.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating spread spectrum communications and more particularly to high data rate and low energy communications exploiting coding domain in order to reduce the number of bits transmitted.

In accordance to an embodiment of the invention there is provided a method comprising:
receiving a block of N_{b} bits to be transmitted;
mapping (N_{b}−n) bits of the block of N_{b} bits against a selected code of a set of 2^{(N}^{_{b}}⁻ⁿ⁾ spreading codes where n is the number of bits that will be modulated and transmitted;
transmitting the n bits by using M-digital modulation and spreading the resultant symbols representing the n bits using the selected code of the set of 2^{(N}^{_{b}}⁻ⁿ⁾ spreading codes.

In accordance with an embodiment of the invention the mapping of data to a selected code of a set of spreading codes results in the transmission of the selected code without modulation as all bits within the data are mapped to the selected code of the set of spreading codes, i.e. in the embodiment supra n=0.

In accordance with an embodiment of the invention the selected code of a set of spreading codes employed to transmit a bit of information is selected in dependence upon a mapping of the bit of information to the set of spreading codes.

In accordance with an embodiment of the invention there is provided a method comprising:
receiving a pair of bits to be transmitted;
selecting a predetermined code of a plurality of codes in dependence upon the value of (N_{b}−n) bits spreading the symbol with n bits to be transmitted using the predetermined code.

In accordance with an embodiment of the invention there is provide a method comprising:
receiving n bits of data over a wireless communications network;
determining a predetermined code of a plurality of codes in dependence upon the most powerful correlator output of a set of 2^{(N}^{_{b}}⁻ⁿ⁾ different correlators, where N_{b} bits were received for transmission but only n bits were physically transmitted;
demodulating the selected most powerful correlator output to decode the transmitted symbol;
determining the values of (N_{b}−n) bits in dependence upon the predetermined code of the plurality of codes.

In accordance with an embodiment of the invention there is provided a method comprising:
receiving a spread symbol data over a wireless communications network;
determining a predetermined code of a plurality of codes in dependence upon the received spread symbol data;
associating a value to a first decoded symbol based upon the outputs of a plurality of de-spreading circuits, each de-spreading circuit de-spreading a predetermined code of the plurality of codes;
determining the values of a plurality of bits of data in dependence upon the first decoded symbol and a de-spreading circuit of the plurality of de-spreading circuits meeting a predetermined condition.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a transmitter structure for CIM wireless communications according to an embodiment of the invention for n=2 and N_{b}=4;

FIG. 1B depicts a receiver structure for CIM wireless communications according to an embodiment of the invention for n=2 and N_{b}=4;

FIG. 2 depicts simulated bit error probability expressions for DS-SS according to the prior art and CIM according to an embodiment of the invention for a spreading factor of 32 over AWGN and Rayleigh fading channels within SS-QPSK and SS 16-PSK;

FIG. 3 depicts throughout comparison of DS-SS according to the prior art and CIM according to an embodiment of the invention for a spreading factor of 32 over an AWGN channel; and

FIG. 4 depicts BER performance comparison of SS 16-PSK encoding according to the prior art and code modulation encoding according to embodiments of the invention for AWGN channel and spreading gain L=64; and

FIG. 5 depicts BER performance comparison of SM encoding according to the prior art and code modulation encoding according to embodiments of the invention.

### DETAILED DESCRIPTION

The present invention is directed to spread spectrum communications and more particularly to high data rate and low energy communications by exploiting coding domain which leads to a reduction in the number of bits transmitted.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims. Within these embodiments of the invention a block of bits of two bits, N_{b}=4, is considered with the number of transmitted bits being a single bit, n=2, although the invention may be generalized for different N_{b} and n. Such an embodiment <N_{b}=4:n=2> based upon analysis by the inventor represents a beneficial tradeoff between complexity energy efficiency data rate and Bit Error Rate (BER) performance.

### A: System Model

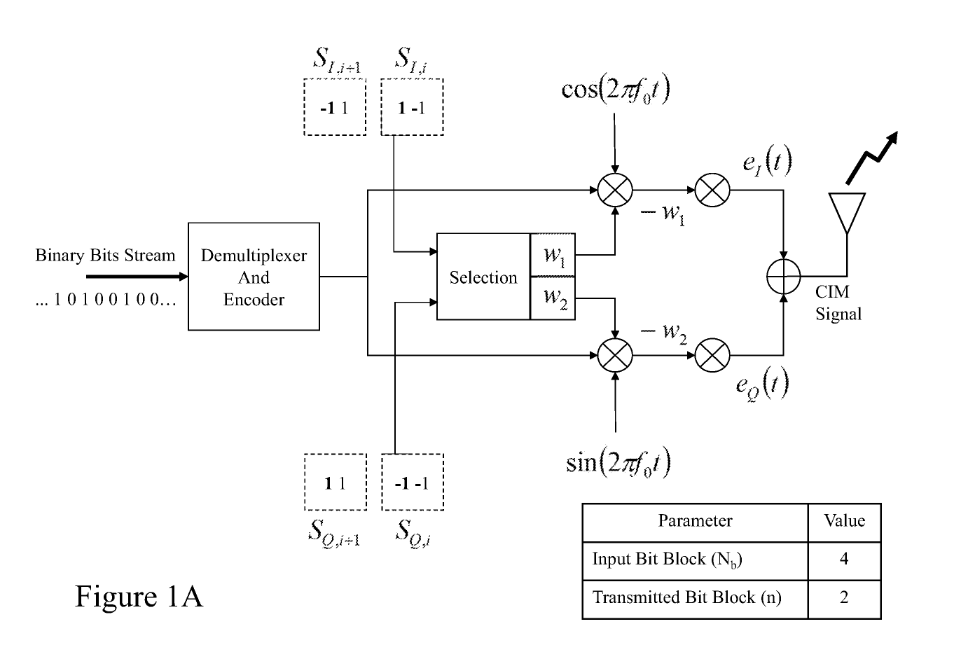

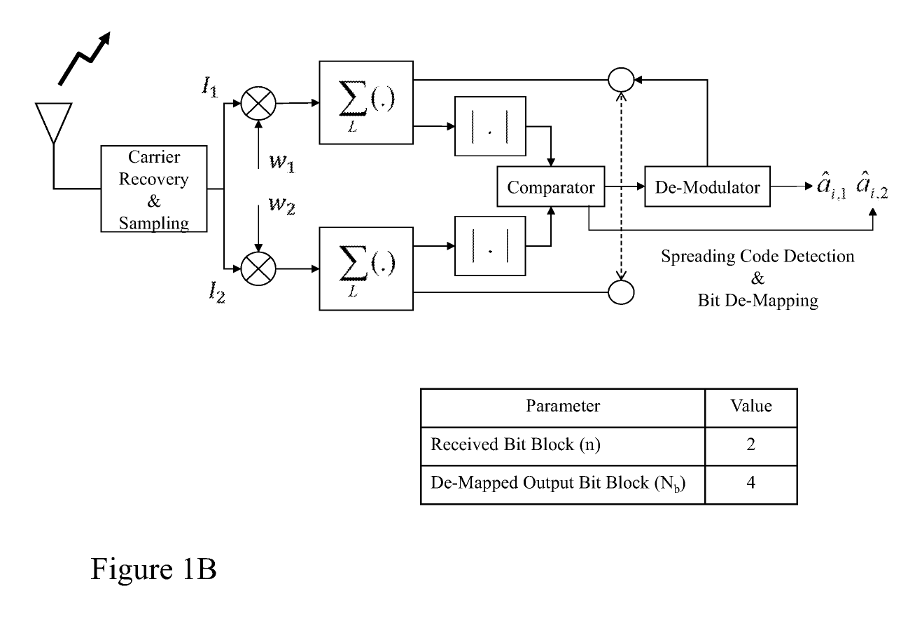

The system model for the code index modulation-(CIM) concept is depicted in FIGS. 1A and 1B for the transmitter and receiver respectively for n=2 and N_{b}=4. The transmitter, as depicted in FIG. 1A, employs a quadrature phase-shift keying (QPSK) modulation, because n=2, and DS-SS. The information bits, which take the values {−1, +1}, are divided between in-phase and quadrature-phase branches and arranged into blocks of two bits each. Since the in-phase and quadrature-phase components are similar, we consider the in-phase component in the following analysis and the expressions for the quadrature phase component will be the same. For the i th in-phase block s_{I,i}=(a_{1,i}, a_{2,i}) wherein the first bit a_{1,i} is multiplied by a spreading code selected by the second bit a_{2,i}. Since a_{2,i} has two values, i.e. a_{2,i}∈{−1, +1}, two different orthogonal codes can be selected, for example w₁(t) if a_{2,i}=1 or w₂(t) if a_{2,i}=−1. According to an embodiment of the invention Walsh codes were selected for the orthogonal codes due to their perfect orthogonality properties although it would be evident that other codes with good correlation properties may be employed. Accordingly, the transmitted in-phase CIM signal e₁(t) is given by Equation (1) where (i.e. two branches I and Q) is the number of transmitted blocks per branch, {w_{1,k}, w_{2,k}} is the Walsh code chip sequence with chip period T_{c} and length L chips, f₀ is the carrier frequency, and p(t) is the pulse shaping filter. In an embodiment of the invention the pulse shaping filter is a rectangular pulse of unit amplitude on [0, T_{c}]. As wₐ_{_{2,i}}_{,k} is selected by a_{2,i} in order to spread a_{1,i} then we denote a_{1,i} as the transmitted bit and a_{2,i} as the mapped bit, Since each transmitted bit a_{1,i} contains a mapped bit a_{2,i}; in the spreading code selection, then the proposed CIM according to an embodiment of the invention doubles the data rate for the same bandwidth and accordingly reduces by 50% the transmitted energy as compared to the conventional DS˜SS.

$$\begin{matrix}{e}_{I} ( t ) = {\sum }_{i = 1}^{N} {\sum }_{k = 1}^{L} {a}_{l , k} {w}_{{a}_{2 , i} , k} p ( t - ( iL + k ) {T}_{c} ) cos ( 2 π {f}_{0} t ) & ( 1 ) \\ {r}_{I} ( t ) = {e}_{I} ( t ) + n ( t ) & ( 2 )\end{matrix}$$

Now considering the receiver, depicted in FIG. 1B, then this has two branches for the in-phase signal, one for each spreading code, The received in-phase signal is given by Equation (2) where n(t) is a representation of additive white Gaussian noise (AWGN) with zero mean and variance equal to N₀/2. After baseband signal recovery and sampling, a correlator is employed to detect the spreading code. The received sampled signal is multiplied at each branch by the corresponding Walsh code and summed over the bit duration L·T_{c}. Accordingly, the output of the first branch of the receiver can be expressed as Equation (3) where E_{b}=Σ^{L}ₖ₌₁w²_{1,k} and n₁=Σ^{L}ₖ₌₁nₖw_{1,k} is the AGWN multiplied by the first Walsh code. In a similar manner the output at the second branch can be found to be as given by Equation (4) where n₁=Σ^{L}ₖ₌₁nₖw_{2,k} is the corresponding noise term.

$$\begin{matrix}{I}_{1 , i} = \{ \begin{matrix}{a}_{1 , i} {E}_{b} + {n}_{1} & if {w}_{1} transmitted \\ 0 + {n}_{1} & if {w}_{2} transmitted\end{matrix} ( \begin{matrix}i . e . {a}_{2 i} = + 1 \\ i . e . {a}_{2 , i} = - 1\end{matrix} ) & ( 3 ) \\ {I}_{1 , i} = \{ \begin{matrix}o + {n}_{2} & if {w}_{1} transmitted \\ {a}_{1 , i} {E}_{b} + {n}_{2} & if {w}_{2} transmitted\end{matrix} ( \begin{matrix}i . e . {a}_{2 , i} = + 1 \\ i . e . {a}_{2 , i} = - 1\end{matrix} ) & ( 4 )\end{matrix}$$

The absolute values of the correlator's output are compared, i.e. selecting the maximum value of the different branches outputs, in order to detect the transmitted Walsh code based on the decision variable Dᵢ=|_{1,i}|−|I_{2,i}| and hence the mapped bit a_{2,i} is found. The corresponding branch selected by the comparator is then used to recover the transmitted bit a_{1,i} through the sign of its correlator output. Accordingly, the two bits can be recovered as given by Equations (5A) and (5B). The absolute value of the received signal is employed within this embodiment because it is easy to implement and the inventor has found it to give better performance than detection with two thresholds, although this could be alternatively used. The improved performance of the proposed CIM system is shown by the analysis in the following Section B. The sign is employed here because of the use of QPSK modulation. However in other general schemes the sign represents the demodulator.

Dᵢ>0 a_{2,i}=+1 and a_{1,i}=sign(I_{1,i}) (5A)

Dᵢ≦0 a_{2,i}=−1 and a_{1,i}=sign(I_{2,i}) (5B)

### B. CIM Performance Analysis

Within this analysis the bit error rate performance of the CIM over an AWGN channel is derived together with the throughput, energy consumption, and total system complexity which are compared to the conventional prior art DS-SS systems, i.e. SS QPSK and SS 16-PSK.

B1: Bit-Error Rate (BER): The total BER P_{T} of the CIM system is a function of the BER of the transmitted bit P_{eb} and the BER of the mapped bit P_{ec} which corresponds to the error probability of the spreading code detection sequence. Accordingly, within the simulated embodiment where there is only one transmitted bit a_{1,i} and one mapped bit a_{2,i} with each spreading code, the total BER P_{T} of the CIM system is given by Equation (6). From Equation (5) it is evident that the error of the transmitted bit a_{1,i} depends on the comparator decision and occurs in two different cases. The first case is when there is no error in the spreading code detection, but the transmitted bit a_{1,i} is detected with an error. The second case is when there is an error in the code detection since a_{1,i} is detected based on the sign of the wrong correlator output. Therefore, the BER P_{eb} of the transmitted bit a_{1,i} is given by Equation (7) where Pₛₛ=0.5 erƒc(\sqrt{E_{b}/N₀}) is the BER for the conventional DS-SS (i.e. DS-SS with QPSK) over AWGN and erƒc is the complementary error function, see for example Tse et al in “Fundamentals of Wireless Communications” (Cambridge University Press, 2005).

P_{T}=½P_{eb}+½P_{ec} (6)

P_{eb}=Pₛₛ(1−P_{ec})+½P_{ec} (7)

The two terms in Equation (7) represent the two error cases respectively. Also, the factor of 0.5 represents the fact that with error in the code detection, the bit value detected based on the sign of the wrong correlator output still matches the transmitted bit a_{1,i} half of the time.

Computing Equations (6) and (7) requires finding the error probability of spreading code detection P_{ec}. As seen in Equation (5), the decision variable Dᵢ is compared to zero and the result determines the spreading code. The decision variable Dᵢ can be approximated as a nearly Gaussian random variable, see for example Morales-Jimenez et al in “Multiple-Antenna Signal Detection in Cognitive Radio Networks with Multiple Primary User Signals” (arXiv:1405.6408), then the mean and variance of the decision variable Dᵢ are initially computed. Since the outputs in Equations (3) and (4) are symmetric, then we can consider one case and the other one is similar. Accordingly, assume the code w₁ is transmitted, i.e. a_{2,i}=1, then Dᵢ is given by Equation (8) and the mean E{Dᵢ} of Dᵢ is given by Equation (9).

Dᵢ=|I_{1,i}|−|I_{2,i}|=|E_{b}+n₁|−|n₂| (9)

The two terms in Equation (9) are independent because the noise signal is multiplied by two different Walsh codes. Accordingly, we can write the first term as E{|E_{b}+n₁|}=E|X| where X=E_{b}+n₁ is a random normal distribution with mean E_{b}, and variance E_{b}N₀/2, i.e. X˜ [symbol] (E_{b}, E_{b}N₀/2), then the mean E{|X|} can be developed as Equation (10A) and (10B).

$$\begin{matrix}E \{ \vert X \vert \} = \frac{1}{\sqrt{π {E}_{b} {N}_{0}}} {\int }_{- ∞}^{+ ∞} \vert X \vert {e}^{\frac{{( X - {E}_{b} )}^{2}}{{E}_{b} {N}_{0}} dX} & ( 10 A ) \\ = \sqrt{\frac{{E}_{b} {N}_{0}}{π}} {e}^{( \frac{{E}_{b}}{{N}_{0}} )} + {E}_{b} erf ( \sqrt{\frac{{E}_{b}}{{N}_{0}}} ) & ( 10 B )\end{matrix} \qquad ( 10 B )$$

Further, as |n₂| follows a half-normal distribution with mean

$$E \{ \vert {n}_{2} \vert \} = \sqrt{\frac{{E}_{b} {N}_{0}}{π}}$$

from Equation (10). Hence, the mean of the decision variable D, is given by Equation (11). The variance V{Dᵢ} of the decision variable can be written as Equation (12).

$$\begin{matrix} E \{ {D}_{i} \} = ( {e}^{( \frac{{E}_{b}}{{N}_{0}} )} - 1 ) \sqrt{\frac{{E}_{b} {N}_{0}}{π}} + {E}_{b} erf ( \sqrt{\frac{{E}_{b}}{{N}_{0}}} ) & ( 11 ) \\ V \{ {D}_{i} \} = E \{ {D}_{i}^{2} \} - E {\{ {D}_{i} \}}^{2} = E \{ {E}_{b}^{2} \} + E \{ {n}_{1}^{2} \} + E \{ {n}_{2}^{2} \} - 2 E \{ \vert {E}_{b} + {n}_{1} \vert \} E \{ \vert {n}_{2} \vert \} - E {\{ {D}_{i} \}}^{2} & ( 12 )\end{matrix}$$

By substituting Equation (10) into Equations (11) and (12) and after some straightforward manipulations, the total variance can be expressed as Equation (13).

$$\begin{matrix}V \{ {D}_{i} \} = {E}_{b}^{2} - \sqrt{\frac{{E}_{b} {N}_{0}}{π}} ( {e}^{( \frac{{E}_{b}}{{N}_{0}} )} ( 1 + 2 \sqrt{\frac{{E}_{b} {N}_{0}}{π}} ) - 1 ) + {E}_{b} ( {N}_{0} + erf ( \sqrt{\frac{{E}_{b}}{{N}_{0}}} ) ( 1 - 2 \sqrt{\frac{{E}_{b} {N}_{0}}{π}} ) ) & ( 13 ) \\ {P}_{ec} \approx \frac{1}{2} erfc ( \frac{E [ {D}_{i} ]}{\sqrt{2 V [ {D}_{i} ]}} ) & ( 14 )\end{matrix}$$

The error probability of spreading code detection under Gaussian approximation can be expressed as given by Tse in Equation (14). Hence, the closed-from expression of the error probability P_{ec}, is obtained by substituting Equations (11) and (13) in Equation (14). Finally, the total BER of the CIM system under AWGN channel is obtained by substituting Equations (14) and (7) in Equation (6).

B2) Throughput: Typically, the throughput is defined as the number of correct bits that a user receives per unit time and thus can be written as Equation (15), after Tse, where M is the modulation order, T is the transmission time, and (1-P) is the correct bits received during time T. Both DS-SS and CIM systems have the same bit duration T=LT_{c}. However, two bits are transmitted over T with QPSK for the DS-SS system whilst four bits are transmitted for the CIM system according to an embodiment of the invention.

B3) Energy Efficiency, Data Rate, and System Complexity: Within the CIM transmission system according to the embodiment of the invention described sup the proposed CIM scheme for n=2 and N_{b}=4, only half of the information bits are directly transmitted. With each transmitted bit in the in-phase and quadrature-phase components, another bit is conveyed in the spreading code selection. This process saves 50% of the total transmitted energy and doubles the data rate of the system as compared to the conventional DS-SS.

The complexity of the schemes is evaluated by considering the number of spreading/de-spreading operations required to transmit one bit. At the transmitter side the CIM scheme requires one spreading operation to transmit one bit which is the same number of operations required for DS-SS case. In the case of n=2 and N_{b}=4, two de-spreading operations are required for the CIM instead of one operation for the DS-SS system. However, to transmit N_{b} bits, the CIM system requires N_{b}/2 spreading operations at the transmitter and N_{b} de-spreading operations at the receiver for a total of 3/2N_{b} operations whilst the DS-SS system requires N_{b} spreading operations and N_{b}, de-spreading operations. Therefore, if we neglect the comparator complexity. The CIM system is approximately 25% less complex than the DS-SS scheme. This lower complexity also reduces the energy consumption due to computations.

### C: Simulation Results

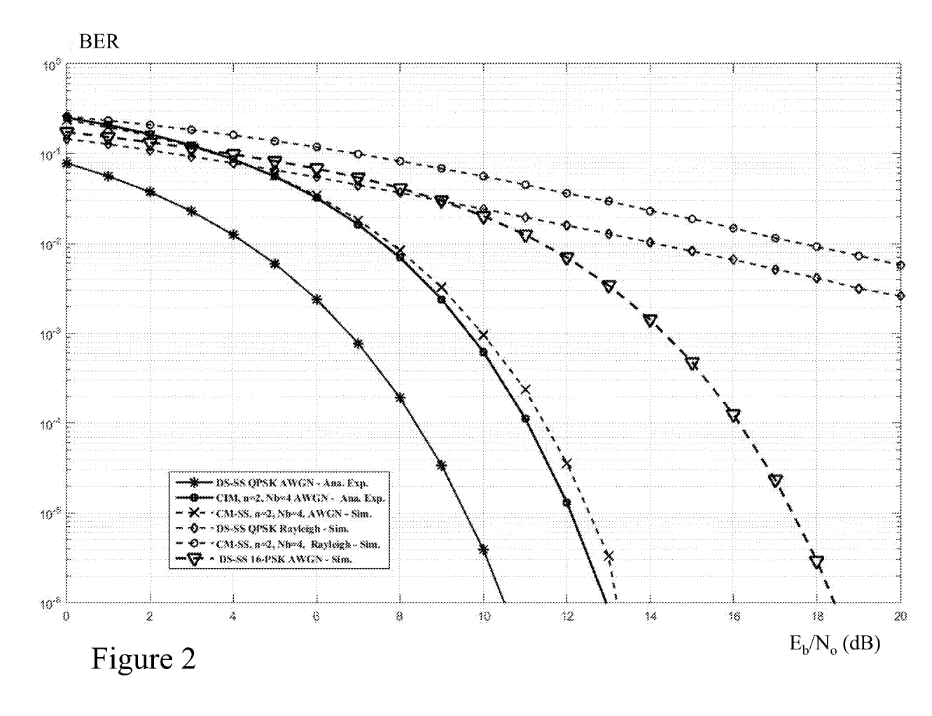

In order to demonstrate the performance of the CIM system according to an embodiment of the invention the system was analysed by numerical simulations. Referring to FIG. 2 there is depicted a plot of the theoretical BER expression given by Equation (6) under AWGN channel conditions comparing the obtained performance with the conventional DS-SS system. In order to give further insight into the expected performance under different channels, FIG. 2 also depicts the simulated performance of the two schemes under flat fading Rayleigh channel with average power gain equal to 0.5. As evident from FIG. 2 there is a small difference between the theoretical error expression P_{T} and simulation results which results from the approximation of the decision variable Dᵢ as a Gaussian random variable. However, the results validate the Gaussian approximation as an acceptable assumption which simplifies the theoretical analysis with just a small error in the final results.

Further, from the analysis it is evident that that the conventional SS QPSK system outperforms CIM systems according to an embodiment of the invention by about 3 dB for both AWGN and Rayleigh channels. Based on our analytical analysis given in Equation (6), this 3 dB degradation comes from the error in the code detection. However, as shown in the same figure the performance degradation gap between SS QPSK and higher order modulation with four bits per symbol like SS 16-PSK over AWGN channel is 8 dB which is higher than the 3 dB gap with the CIM system according to embodiments of the invention. This arises as the mapped bits do not reduce the Euclidian distance between the transmitted bits as in the conventional modulation. Accordingly, the proposed CIM system according to embodiments of the invention actually increases the data rate with a 5 dB higher gain in terms of BER than the equivalent conventional higher order modulation schemes such as SS 16-PSK.

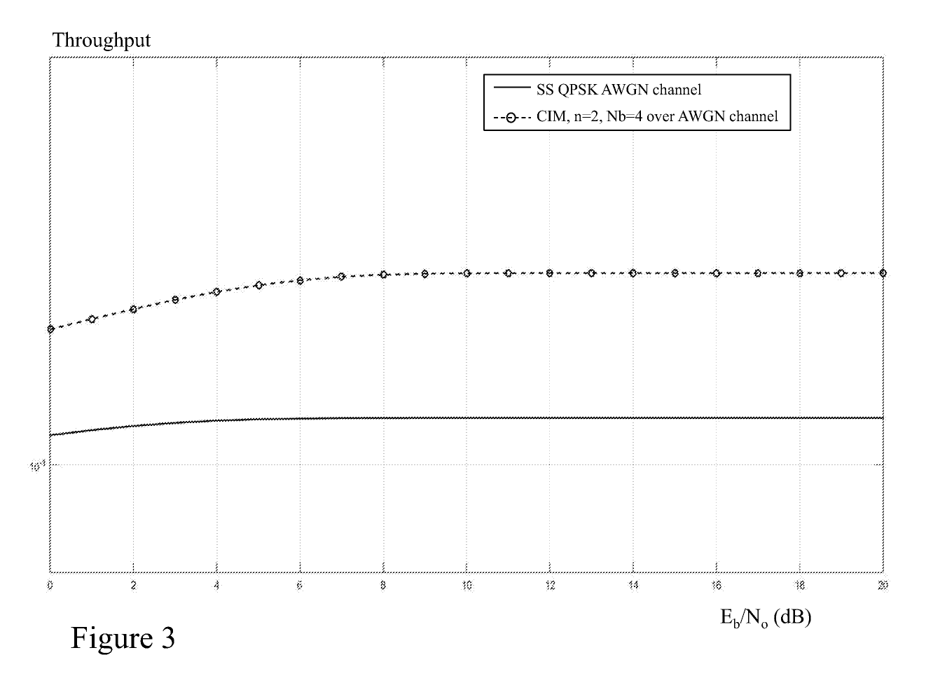

Now referring to FIG. 3 the throughput for the proposed CIM according to an embodiment of the invention is compared with the conventional SS QPSK system obtained by Equation (15), As evident in FIG. 3, the CIM scheme offers a higher throughput than the DS-SS because, for the same period T, four bits are sent over the channel in the CIM system where two bits are physically transmitted and two bits are mapped with the spreading code. Consequently, the proposed system outperforms the conventional SS QPSK system whilst reducing energy consumption of transmission by 50% and also being 25% less complex.

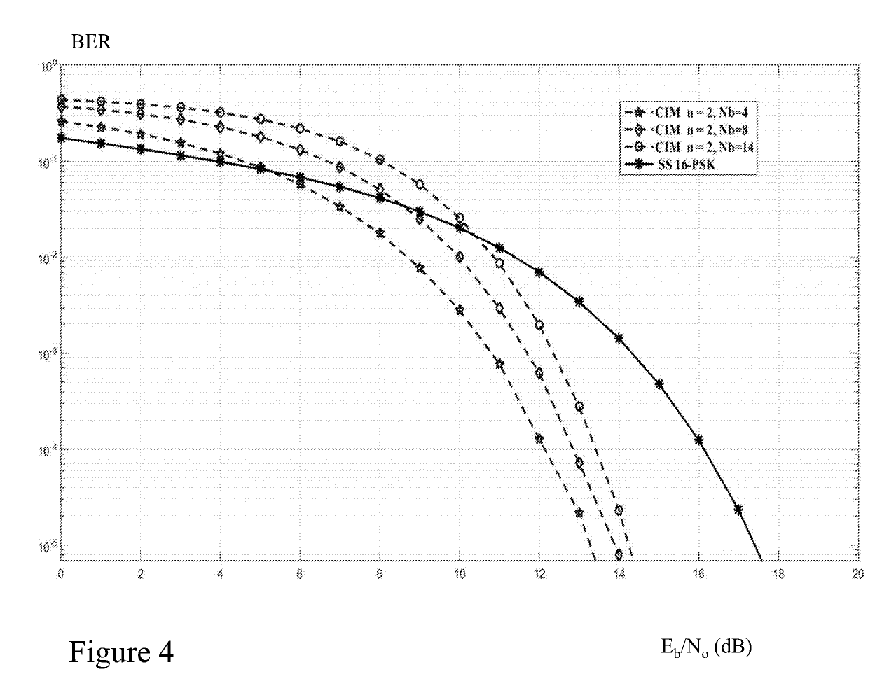

Now referring to FIG. 4 there are depicted simulation results for the CIM encoding versus prior art SS 16-PSK encoding for the same number of bits per symbol and even for higher constellation orders when the SNR is high. Results for SS 64-PSK and SS 256-PSK systems are not plotted in the same figure because the result is straightforward since the CIM scheme already outperforms the SS 16-PSK method. This performance gain can be attributed to the fact that the inventive system provides larger Euclidean distance between the constellation symbols for the modulated bits. For the CIM scheme, SS QPSK modulation is used and its Euclidean distance remains constant with increasing the number of mapped bits and can explain the slow degradation in performance when the mapped bits are increased as compared to the conventional modulation. In contrast in prior art SS N-PSK the Euclidean distance decreases when the number of bits per symbol increases.

Whilst both CIM according to embodiments of the invention and prior art space modulation (SM) are similar in using an additional dimension to carry information bits, there are some advantages that make the CIM scheme more attractive for practical implementations. The performance of the CIM depends on the orthogonality characteristics of the spreading codes rather than the channel characteristics. The performance of the SM degrades when the channels are correlated due to the inadequate spacing between antennas. Using spreading codes rather than the antenna as an extra dimension for mapping bits moves the design challenge to finding spreading codes with good orthogonality characteristics. Moreover, the SM requires multiple antennas at the transmitter, i.e., more cost is added to the hardware implementation. In addition, the number of mapped bits in the SM is limited by the physical size of the wireless device where only small number of antennas can be used. On the other hand, CIM can use a very large number of codes by increasing the number of mapped bits without increasing the physical size and cost.

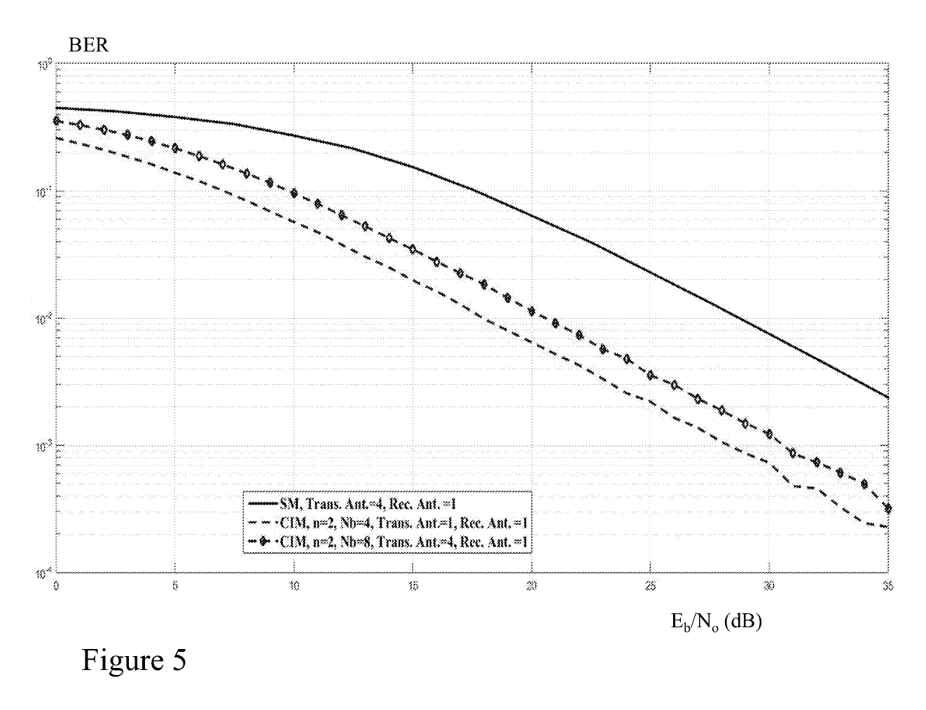

Now referring to FIG. 5 there is depicted a comparison between the inventive CIM technique and the prior art SM technique. In this comparison, the inventors use the SS-QPSK modulation for the SM and compare it with the CIM modulation for n=2 (i.e. SS-QPSK) and a different number of mapped bits N=1, 3, 5 and spreading gain L=64. A quasi static flat fading Rayleigh channel with mean average power equal to $0.5$ was used for both systems and the channels are uncorrelated for the SM system. In addition, perfect knowledge of channel state information is assumed at the receiver side for both systems. In this comparison, the SM uses four antennas at the transmitter side and one antenna at the receiver side while a single antenna is used in the CIM at the transmitter and receiver sides. A maximum likelihood (ML) receiver was used for SM to estimate the transmit antennas number and retrieve the corresponding mapped symbol. For SM scenario, each received signal contains the modulated symbol and the mapped symbol corresponding to the active antenna which is equivalent to CIM system with n=2 and N=1 in terms of transmitted bits. FIG. 5 shows that the inventive CIM system outperforms the prior art SM system in BER performance even for $N=3$. In this case, the CIM achieves 8 bits per transmission instead of 4 bits for the SM system with lower complexity.

### E. Expansions

Enhancements in CIM system performance may arise from multiple sources, including, but not limited to improving the code detection algorithm in order to improve the total BER performance of the CIM system. It would also be evident that the CIM concept supports transmission over other different fading channels. Further the CIM concept may be generalized to extend the concept for more than one mapped bit. The CIM concept may also be integrated with other techniques, including but not limited to, other spatial modulations and Multi-Input-Multi-Output methodologies.

It would be evident to one skilled in the art that the technique described supra in respect of code modulation-spread spectrum represents one mapping methodology according to an embodiment of the invention. Other mapping methodologies may be employed wherein one bit of a pair of bits being transmitted is mapped to a “code” employed in transmitting the other bit and wherein the code employed is detected at the receiver allowing that bit to be decoded and then the second bit may be concurrently or subsequently decoded based upon the code employed. For example, within a Frequency Hopping Spread Spectrum (FH-SS) communications system the frequency or frequencies employed may be the code.

Whilst the embodiment of the invention described and depicted in respect of FIG. 1 exploits only two different codes it would be evident that mapping of the bit to one of a larger number of codes may be performed without departing from the scope of the invention. For. The required number of codes depends of the number of mapped bits which is equal to 2^{(N}^{_{b}}⁻ⁿ⁾. There is no increase in complexity at the transmitter side but there is a corresponding increase in the complexity of the receiver as now the receiver requires correlators for all 2^{(N}^{_{b}}⁻ⁿ⁾ codes and must despread and correlate the codes to extract the mapping. Accordingly, it would be evident that there exists a tradeoff in the complexity of the receiver and the degree of “virtual transmitting” of data by the particular code employed. Within other embodiments of the invention the code may itself require multiple bits long for determination.

In some embodiments of the invention the determination of the code may be performed within a field programmable gate array (FPGA) and may simply be reduced in some instances to a sequential series of “IF (X) THEN (Y)” processes. As such without any change in hardware complexity the coding employed may be varied and/or established according to a variety of factors including, but not limited, the application, the network requirements, wireless environment, device complexity, and device power requirements.

In addition to frequency hopping spread spectrum (FH-SS) techniques wireless communications according to embodiments of the invention may exploit time-hopping spread spectrum (TH-SS), direct sequence spread spectrum (DS-SS) and chirp spread spectrum (CSS) techniques.

Embodiments of the invention may be employed in the establishment of high data rate and low energy wireless communications between wireless devices and network infrastructure including, but not limited to, cell towers, WiFi nodes, WiMAX nodes, Zigbee nodes, wireless sensors networks, satellite communications, global navigation systems (GPS, Galileo etc . . . ), triangulation location systems, body area networks, etc. as well as local or personal device to device communications and local or personal device to network communications, personal area networks, wearable devices, wearable sensors, sensor networks, etc. Embodiments of the invention may be employed in fixed networks as well as ad-hoc networks.

It would also be evident that embodiments of the invention may be employed with low/medium data rate and low energy wireless communications between client devices including, but not limited to, uniquely identifiable embedded computing-like devices within existing and future Internet infrastructures (e.g. devices forming element of the Internet of Things) and network elements including, but not limited to, base stations and access points. In such applications client devices may, by limiting the amount of data transmitted, extend the operating lifetime of the client devices.

Embodiments of the invention may be employed in conjunction with “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

Embodiments of the invention may be employed in conjunction with “fixed electronic device” (FED) as used herein and throughout this disclosure, refers to a wireless device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” or “wearable sensor” refers to a wireless electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

Embodiments of the invention may be employed within wireless communications systems according to internationally recognized standards, national standards, industry standards, ad-hoc standards as well as discrete networks and systems or deployments of networks and systems operating to specifications defined by the manufacturer and/or purchaser of the network and/or system. Embodiments of the invention may also be implemented using a variety of transmission protocols including, but not limited to, analog modulation, digital modulation, amplitude modulation, frequency modulation, phase modulation, shift keying, and single sideband modulation.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. The method according to claim 18, further comprising:
receiving a block of N_{b} bits to be transmitted;
mapping (N_{b}−n) bits of the block of N_{b} bits against a selected code of a set of 2^{(N}^{_{b}}⁻ⁿ⁾ spreading codes where n is the number of bits that will be modulated and transmitted;
transmitting the n bits by using M-digital modulation and spreading the resultant symbols representing the n bits using the selected code of the set of 2^{(N}^{_{b}}⁻ⁿ⁾ spreading codes.

2. The method according to claim 1, wherein
the mapping of data to a selected code of the set of spreading codes results in the transmission of the selected code without modulation as n=0 and all bits within the data are mapped to the selected code of the set of spreading codes.

3. The method according to claim 1, wherein
the selected code of the set of spreading codes employed for transmitting the bit of information is selected in dependence upon the mapping of the bit of information to the set of spreading codes.

4. The method according to claim 1, wherein
the number spreading codes within the set of spreading codes is 2^{(N}^{_{b}}⁻ⁿ⁾.

5. The method according to claim 1, wherein
N_{b}=4 and n=2.

6. The method according to claim 19, further comprising:
receiving a bit of data over the wireless communications network;
determining a predetermined code of a plurality of codes in dependence upon the received bit;
associating a value to a first decoded symbol based upon the predetermined code of the plurality of codes;
determining a plurality of decoded bits in dependence upon the predetermined code of the plurality of codes and the received bit.

7. The method according to claim 6, wherein the plurality of codes relate to spread-spectrum communication codes.

8. The method according to claim 6, wherein
the plurality of codes all relate to a spread spectrum communications protocol, the spread spectrum communications protocol selected from the group comprising code modulation spread spectrum, frequency hopping spread spectrum, direct sequence spread spectrum and chirp spread spectrum.

9. The method according to claim 19, further comprising:
receiving n bits of data over the wireless communications network;
determining a predetermined code of a plurality of codes in dependence upon the most powerful correlator output of a set of 2^{(N}^{_{b}}⁻ⁿ⁾ different correlators, wherein N_{b} bits were received for transmission but only n bits were physically transmitted;
demodulating the selected most powerful correlator output to decode the transmitted symbol;
determining the values of (N_{b}−n) bits in dependence upon the predetermined code of the plurality of codes.

10. The method according to claim 9, wherein
(N_{b}−n) represents the number of bits within a block of data to be mapped by the selected spread spectrum code and n is the number of bits that will be transmitted;

11. The method according to claim 9, wherein
the plurality of codes relate to spread spectrum communication codes.

12. The method according to claim 9, wherein
the plurality of codes all relate to a spread spectrum communications protocol, the spread spectrum communications protocol selected from the group comprising code modulation spread spectrum, frequency hopping spread spectrum, direct sequence spread spectrum and chirp spread spectrum.

13. The method according to claim 19, further comprising:
receiving a spread symbol data over the wireless communications network;
determining a predetermined code of a plurality of codes in dependence upon the received spread symbol data;
associating a value to a first decoded symbol based upon the outputs of a plurality of de-spreading circuits, each de-spreading circuit de-spreading a predetermined code of the plurality of codes;
determining the values of a plurality of bits of data in dependence upon the first decoded symbol and a de-spreading circuit of the plurality of de-spreading circuits meeting a predetermined condition.

14. The method according to claim 13, wherein
the predetermined condition is the output of that de-spreading circuit of the plurality of de-spreading circuits is higher than the other outputs.

15. The method according to claim 18, further comprising:
receiving a pair of bits to be transmitted;
selecting a predetermined code of a plurality of codes in dependence upon the value of N_{b}−n) bits spreading the symbol with n bits to be transmitted using the predetermined code.

16. The method according to claim 19, further comprising:
receiving a bit of data over the wireless communications network;
determining a predetermined code of a plurality of codes in dependence upon the most powerful correlator output of a set of 2^{(N}^{_{b}}⁻ⁿ⁾ different correlators, where N_{b} bits were received for transmission but only n bits were actually transmitted;
demodulating the selected most powerful correlator output to decode the transmitted symbol;
determining the values of (N_{b}−n) bits in dependence upon the predetermined code of the plurality of codes.

17. The method according to claim 19, further comprising:
receiving spread symbol data over the wireless communications network;
determining a predetermined code of a plurality of codes in dependence upon the received spread symbol data;
associating a value to a first decoded symbol based upon the outputs of a plurality of de-spreading circuits, each de-spreading circuit de-spreading a predetermined code of the plurality of codes;
determining the values of a plurality of bits of data in dependence upon the first decoded symbol and a de-spreading circuit of the plurality of de-spreading circuits meeting a predetermined condition.

18. A method for transmitting data within a wireless communications network with increased efficiency.

19. A method of receiving data within a wireless communications network with increased efficiency.
